(19) United States
(12) Patent Application Publication
(10) Pub. No.: US 2022/0303306 A1
(43) Pub. Date: Sep. 22, 2022

(54) COMPRESSION OF UNIFORM RESOURCE LOCATOR SEQUENCES FOR MACHINE LEARNING-BASED DETECTION OF TARGET CATEGORY EXAMPLES

(71) Applicant: AT&T Intellectual Property I, L.P., Atlanta, GA (US)

(72) Inventors: Seyed Amir Mir Bagheri, Dallas, TX (US); Vivek Rajasekharan, Plano, TX (US); James Pratt, Round Rock, TX (US)

(21) Appl. No.: 17/203,099

(22) Filed: Mar. 16, 2021

(51) Int. Cl. H04L 29/06; G06N 20/00; G06N 5/04; G06F 16/955

(52) U.S. Cl. CPC H04L 63/1458; G06N 20/00; G06N 5/04; G06F 16/955

(57) ABSTRACT

A processing system may identify a plurality of uniform resource locators associated with a target category of a plurality users of a communication network, identify a plurality of sequences of URLs, each sequence comprising URLs from among the plurality of URLs, each sequence associated with a user known to be of the target category, and train a machine learning model with the plurality of sequences to detect additional sequences that are indicative of the target category. The processing system may next obtain a set of URLs associated with an additional user, identify a sequence comprising URLs, from among the plurality of URLs, that are contained within the set of URLs, apply the sequence as an input to the machine learning model that has been trained, and obtain an output of the machine learning model quantifying a measure of which the sequence is indicative of the target category.

The present disclosure relates generally to machine learning model deployment, and more particularly to methods, non-transitory computer-readable media, and apparatuses for compressing and identifying sequences of uniform resource locators indicative of a target category.

### BACKGROUND

Machine learning in computer science is the scientific study and process of creating algorithms based on data that perform a task without any instructions. These algorithms are called models and different types of models can be created based on the type of data that the model takes as input and also based on the type of task (e.g., prediction, classification, or clustering) that the model is trying to accomplish. The general approach to machine learning involves using the training data to create the model, testing the model using the cross-validation and testing data, and then deploying the model to production to be used by real-world applications.

### SUMMARY

In one example, the present disclosure describes a method, computer-readable medium, and apparatus for compressing and identifying sequences of uniform resource locators indicative of a target category. For instance, a processing system including at least one processor may identify a plurality of uniform resource locators associated with a target category of a plurality of users of a communication network, identify a plurality of sequences of uniform resource locators, wherein each sequence of the plurality of sequences comprises uniform resource locators from among the plurality of uniform resource locators, wherein each sequence of the plurality of sequences is associated with a user from among the plurality of users known to be of the target category, and train a machine learning model with the plurality of sequences to detect additional sequences that are indicative of the target category. The processing system may next obtain a set of uniform resource locators associated with an additional user, identify a sequence comprising uniform resource locators, from among the plurality of uniform resource locators, that are contained within the set of uniform resource locators, apply the sequence as an input to the machine learning model that has been trained, and obtain an output of the machine learning model quantifying a measure of which the sequence is indicative of the target category. The processing system may then perform at least one action in the communication network responsive to the measure of which the sequence is indicative of the target category.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates a flowchart of an example method for compressing and identifying sequences of uniform resource locators indicative of a target category; and

FIG. 3 illustrates a high level block diagram of a computing device or system specifically programmed to perform the steps, functions, blocks and/or operations described herein.

To facilitate understanding, identical reference numerals have been used, where possible, to designate identical elements that are common to the figures.

### DETAILED DESCRIPTION

Examples of the present disclosure describe methods, computer-readable media, and apparatuses for compressing and identifying sequences of uniform resource locators indicative of a target category. With billions of connected systems on the internet, users and consumers of communication network-based services regularly access uniform resource locators (URLs) (broadly “webpages”) via browsers or other applications. They have similar actions that they take as a result of accessing webpages from site to site. These similar actions that lead to certain propensities can be utilized to compress not only the storage of sequences of URLs that may be accessed by a user, but also compress network traffic using behavior typing of similar combinations within historical URL sets. Additionally, this ensures that relevant URLs to a current topic interest are stored, while other URLs may be discarded, and therefore data access is restricted to desired groups for privacy and security.

With hundreds of millions of subscribers browsing even more numerous websites, it is difficult for machine learning models (MLMs) to learn from raw, voluminous, and complex URL histories. In one example, the present disclosure compresses URL sets/sequences of various users to keep those URLs relevant to a target category, while discarding others (e.g., reducing the data volume/size from, for each user, millions of unique URLs to approximately 200 to 1000 unique URLs, depending upon the particular target category, the desired accuracy of prediction, the available storage volume for storing URL sequences, etc.). In addition, reducing the volume/size of retained URL sequences allows a prediction model (e.g., a machine learning model) to use more relevant, and more important information aggregated over a longer period of time (e.g., multiple days, weeks, etc.), while also providing real-time detection, triggering, and/or alerting in some examples.

In one example, the present disclosure may include four components. A first component may comprise a historical URL sequence database, which may record user interactions on the web (on a per-user and/or per-device basis), such as mobile URLs selected in a sequence. A second component may comprise a path calculator, which may analyze historical URL sequences and determine representative URLs related to a certain target category, or categories. The path calculator may also compress URL sequences of various users relevant to a specific target category, e.g., users associated with fraudulent use of the communication network, users associated with a utilization of a network resource of the communication network, users associated with an accessing of a particular data content or a type of data content via the communication network, users associated with a change in endpoint devices or network access equipment, etc. A third component may comprise a relevant behavior database, which may store compressed URL sequences as defined in the path calculator in order to compress and optimize detection of additional instances that are representative of the target category. In this regard, the present disclosure may also include at least a fourth component, a machine learning model (MLM) for detecting additional instances that are representative of the target category. For instance, compressed URL sequences for users known to be associated with a target category may be used to train the MLM to detect additional instances of the target category, e.g., whether additional users are or are not predicted to be associated with the target category based upon their own respective compressed URL sequences.

In an illustrative example, a user may browse a URL via an endpoint device, which may be recorded at the device and/or in the historical URL sequence database. In one example, a URL sequence (e.g., including the browsed URL) may be sent to the path calculator for analysis. The path calculator may update the URL sequence to prioritize URLs for the target category, e.g., fraudulent use, utilization of a particular network resource, accessing of a particular data content or a type of data content, changing of endpoint devices or network access equipment, etc., on an ongoing basis. For instance, the path calculator may compress the URL sequence by retaining relevant/important URLs and discarding others, and may send the compressed URL sequence to the relevant behavior database. In one example, identified important/relevant URLs may also be used to compress and refresh the URL sequences/histories in the historical behavior database.

The relevant behavior database may store the compressed URL sequence. In one example, the relevant behavior database may also remove sensitive URLs for privacy and security (e.g., banking URLs, URLs relating to medical information, etc.). For instance, these URLs may be deemed important/relevant and may be initially retained per the compression, but may nevertheless be removed to further enhance privacy and security. In one example, a list of sensitive URL may be obtained from network operations personnel or another system storing such a list. The relevant behavior database may also send the compressed URL sequence to a consuming application, e.g., a machine learning model. The compressed URL sequence may be used for training the model (e.g., if the compressed URL sequence is for a user known to be part of the target category (or known to be not part of the target category, for a negative training example)). Alternatively, if the URL sequence is for a user having an unknown status (e.g., it is unknown whether the user is or is not part of the target category), the machine learning model may be used to detect/predict whether the URL sequence is indicative of the target category, after the machine learning model is trained (e.g., is the user part of the target category or will the user be part of the target category). Notably, the machine learning model may be trained and used to make predictions on inputs of hundreds to thousands of URLs rather than millions to hundreds of millions.

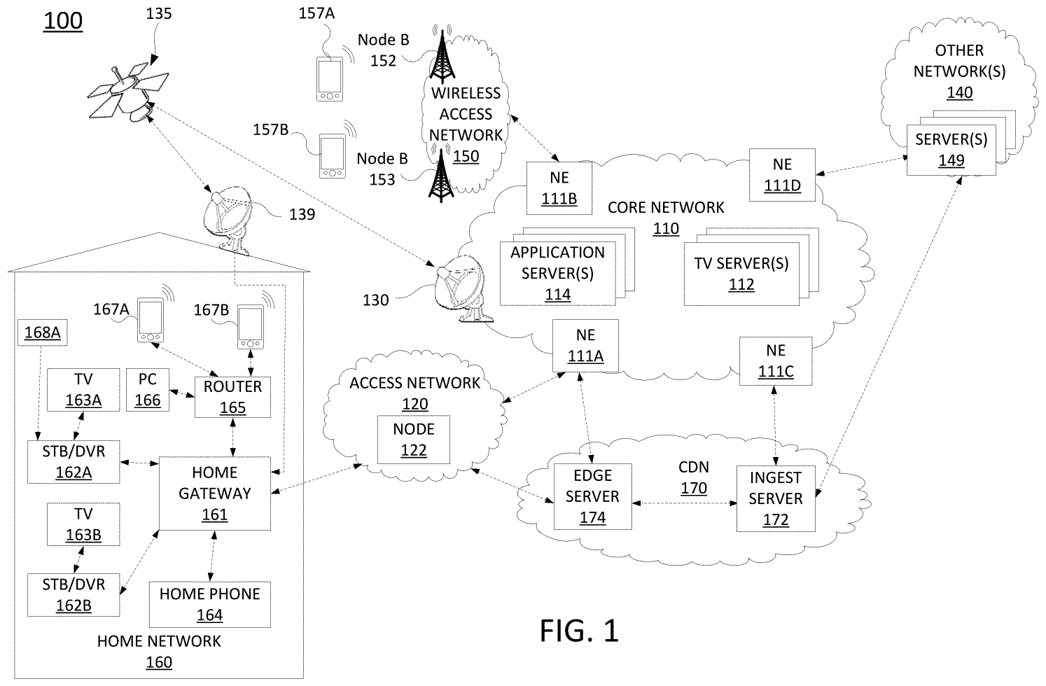

Thus, the present disclosure ensures that URLs and sequences of URLs relevant to the problem at hand are stored, while others are discarded, and therefore the data access is restricted to appropriate groups (e.g., groups who provided their consent) for privacy and security. Notably, previously unknown sources may be uncovered to enhance the relevant behavior database. For instance, seemingly “immaterial” or “irrelevant” URLs may have no indication of the subject matter/content, e.g., URLs of a cloud provider domain followed by random characters. However, these URLs may redirect or may be associated with other domains that may be relevant to the target category. In addition, URL sequences are compressed to realize savings in both data storage as well as the computation and communication of these patterns across the network. URL sequences are processed for communalities in order to update previous URL sequence compressions, e.g., a learning system. Furthermore, examples of the present disclosure may implement network load balance based on knowledge of a number of users in a target category, their locations, device types, network utilization at different times-of-day, days of the week, etc. Similarly automatic software defined network (SDN) network resource instantiation and/or allocation may be adapted based on this information learned in accordance with the present disclosure. These and other aspects of the present disclosure are described in greater detail below in connection with the examples of FIGS. 1-3.

To better understand the present disclosure, FIG. 1 illustrates an example network 100, related to the present examples. As shown in FIG. 1, the network 100 connects mobile devices 157A, 157B, 167A and 167B, and home network devices such as home gateway 161, set-top boxes (STBs) 162A and 162B, television (TV) 163A and TV 163B, home phone 164, router 165, personal computer (PC) 166, and so forth, with one another and with various other devices via a core network 110, a wireless access network 150 (e.g., a cellular network), an access network 120, other networks 140, content distribution network (CDN) 170, and/or the Internet in general. For instance, connections between core network 110, access network 120, home network 160, CDN 170, wireless access network 150 and other networks 140 may comprise the Internet in general, internal links under the control of single telecommunication service provider network, links between peer networks, and so forth.

In one example, wireless access network 150 may comprise a radio access network implementing such technologies as: Global System for Mobile Communication (GSM), e.g., a Base Station Subsystem (BSS), or IS-95, a Universal Mobile Telecommunications System (UMTS) network employing Wideband Code Division Multiple Access (WCDMA), or a CDMA3000 network, among others. In other words, wireless access network 150 may comprise an access network in accordance with any “second generation” (2G), “third generation” (3G), “fourth generation” (4G), Long Term Evolution (LTE), “fifth generation” (5G) or any other yet to be developed future wireless/cellular network technology. While the present disclosure is not limited to any particular type of wireless access network, in the illustrative example, wireless access network 150 is shown as a UMTS terrestrial radio access network (UTRAN) subsystem. Thus, elements 152 and 153 may each comprise a Node B or evolved Node B (eNodeB). In one example, wireless access network 150 may be controlled and/or operated by a same entity as core network 110.

In one example, each of the mobile devices 157A, 157B, 167A, and 167B may comprise any subscriber/customer endpoint device (or “user endpoint device”) configured for wireless communication such as a laptop computer, a Wi-Fi device, a Personal Digital Assistant (PDA), a mobile phone, a smartphone, an email device, a computing tablet, a messaging device, and the like. In one example, any one or more of mobile devices 157A, 157B, 167A, and 167B may have both cellular and non-cellular access capabilities and may further have wired communication and networking capabilities.

As illustrated in FIG. 1, network 100 includes a core network 110. In one example, core network 110 may combine core network components of a cellular network with components of a triple play service network; where triple play services include telephone services, Internet services and television services to subscribers. For example, core network 110 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 110 may also further comprise a broadcast television network, e.g., a traditional cable provider network or an Internet Protocol Television (IPTV) network, as well as an Internet Service Provider (ISP) network. The network elements 111A-111D may serve as gateway servers or edge routers to interconnect the core network 110 with other networks 140, wireless access network 150, access network 120, and so forth. As shown in FIG. 1, core network 110 may also include a plurality of television (TV) servers 112, and a plurality of application servers 114. For ease of illustration, various additional elements of core network 110 are omitted from FIG. 1.

With respect to television service provider functions, core network 110 may include one or more television servers 112 for the delivery of television content, e.g., a broadcast server, a cable head-end, and so forth. For example, core network 110 may comprise a video super hub office, a video hub office and/or a service office/central office. In this regard, television servers 112 may include content server(s) to store scheduled television broadcast content for a number of television channels, video-on-demand (VoD) programming, local programming content, and so forth. Alternatively, or in addition, content providers may stream various contents to the core network 110 for distribution to various subscribers, e.g., for live content, such as news programming, sporting events, and the like. Television servers 112 may also include advertising server(s) to store a number of advertisements that can be selected for presentation to viewers, e.g., in the home network 160 and at other downstream viewing locations. For example, advertisers may upload various advertising content to the core network 110 to be distributed to various viewers. Television servers 112 may also include interactive TV/video-on-demand (VoD) server(s) and/or network-based digital video recorder (DVR) servers, as described in greater detail below.

In one example, the access network 120 may comprise a fiber access network, a Digital Subscriber Line (DSL) network, a broadband cable access network, a Local Area Network (LAN), a cellular or wireless access network, a 3^{rd} party network, and the like. For example, the operator of core network 110 may provide a cable television service, an IPTV service, or any other types of television service to subscribers via access network 120. In this regard, access network 120 may include a node 122, e.g., a mini-fiber node (MFN), a video-ready access device (VRAD) or the like. However, in another example, node 122 may be omitted, e.g., for fiber-to-the-premises (FTTP) installations. Access network 120 may also transmit and receive communications between home network 160 and core network 110 relating to voice telephone calls, communications with web servers via other networks 140, content distribution network (CDN) 170 and/or the Internet in general, and so forth. In another example, access network 120 may be operated by a different entity from core network 110, e.g., an Internet service provider (ISP) network.

Alternatively, or in addition, the network 100 may provide television services to home network 160 via satellite broadcast. For instance, ground station 130 may receive television content from television servers 112 for uplink transmission to satellite 135. Accordingly, satellite 135 may receive television content from ground station 130 and may broadcast the television content to satellite receiver 139, e.g., a satellite link terrestrial antenna (including satellite dishes and antennas for downlink communications, or for both downlink and uplink communications), as well as to satellite receivers of other subscribers within a coverage area of satellite 135. In one example, satellite 135 may be controlled and/or operated by a same network service provider as the core network 110. In another example, satellite 135 may be controlled and/or operated by a different entity and may carry television broadcast signals on behalf of the core network 110.

As illustrated in FIG. 1, core network 110 may include various application servers 114. For instance, application servers 114 may be implemented to provide certain functions or features, e.g., a Serving-Call Session Control Function (S-CSCF), a Proxy—Call Session Control Function (P-CSCF), or an Interrogating—Call Session Control Function (I-CSCF), one or more billing servers for billing one or more services, including cellular data and telephony services, wire-line phone services, Internet access services, and television services. Application servers 114 may also include a Home Subscriber Server/Home Location Register (HSS/HLR) for tracking cellular subscriber device location and other functions. An HSS refers to a network element residing in the control plane of an IMS network that acts as a central repository of all customer specific authorizations, service profiles, preferences, etc. Application servers 114 may also include an IMS media server (MS) for handling and terminating media streams to provide services such as announcements, bridges, and Interactive Voice Response (IVR) messages for VoIP and cellular service applications. The MS may also interact with customers for media session management. In addition, application servers 114 may also include a presence server, e.g., for detecting a presence of a user. For example, the presence server may determine the physical location of a user or whether the user is “present” for the purpose of a subscribed service, e.g., online for a chatting service and the like. It should be noted that the foregoing are only several examples of the types of relevant application servers 114 that may be included in core network 110 for storing information relevant to providing various services to users.

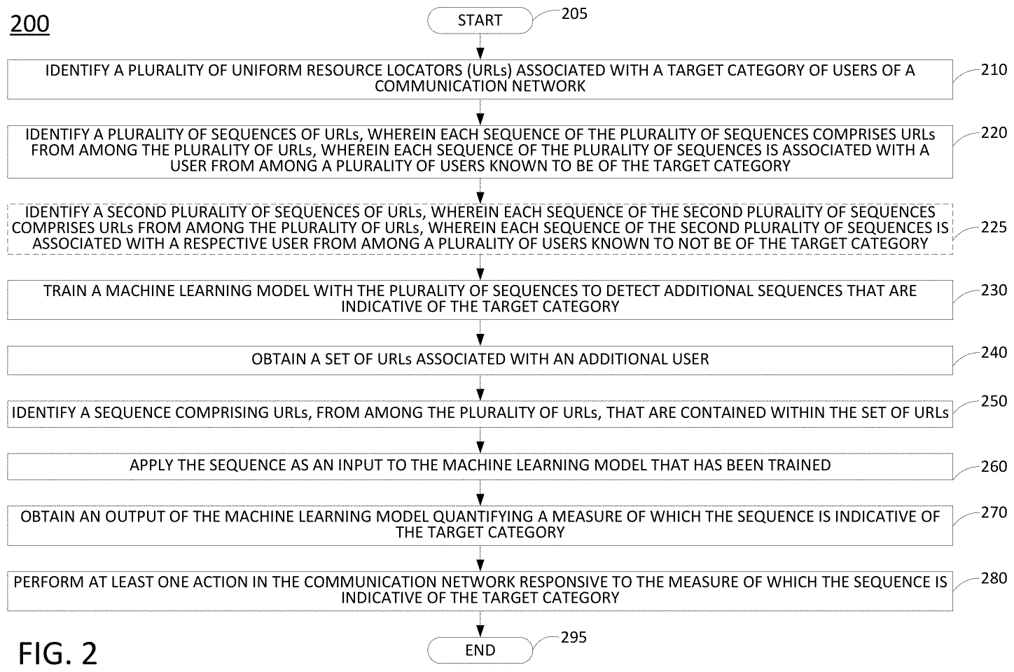

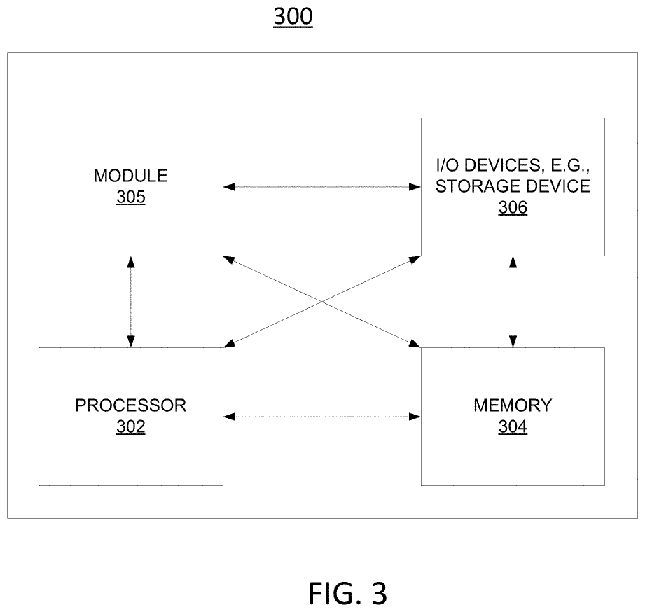

Application servers 114 may also represent a processing system for compressing and identifying sequences of uniform resource locators indicative of a target category. For instance, one or more of application servers 114 may each comprise a computing device or processing system, such as computing system 300 depicted in FIG. 3, and may be configured to perform one or more steps, functions, or operations for compressing and identifying sequences of uniform resource locators indicative of a target category. For instance, an example method for compressing and identifying sequences of uniform resource locators indicative of a target category is illustrated in FIG. 2 and described below. In one example, application server(s) 114 may represent the four components mentioned above of: a historical URL sequence database, a path calculator, a relevant behavior database, and a machine learning model.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 3 and discussed below) or multiple computing devices collectively configured to perform various steps, functions, and/or operations in accordance with the present disclosure.

In accordance with the present disclosure, other networks 140 and servers 149 may comprise networks and devices of various content providers of webpages, documents, videos, or other content items. In one example, servers 149 may represent “origin servers” which may originate content that may be stored in and distributed via content distribution network (CDN) 170. In this regard, the content from servers 149 that may be stored in and distributed via content distribution network (CDN) 170 may include webpages, documents, audio programs, video programs, e.g., movies, television shows, video news programs, sports video content, and so forth, as well as video advertisements.

In one example, home network 160 may include a home gateway 161, which receives data/communications associated with different types of media, e.g., television, phone, and Internet, and separates these communications for the appropriate devices. The data/communications may be received via access network 120 and/or via satellite receiver 139, for instance. In one example, television data is forwarded to set-top boxes (STBs)/digital video recorders (DVRs) 162A and 162B to be decoded, recorded, and/or forwarded to television (TV) 163A and TV 163B for presentation. Similarly, telephone data is sent to and received from home phone 164; Internet communications are sent to and received from router 165, which may be capable of both wired and/or wireless communication. In turn, router 165 receives data from and sends data to the appropriate devices, e.g., personal computer (PC) 166, mobile devices 167A, and 167B, and so forth. In one example, router 165 may further communicate with TV (broadly a display) 163A and/or 163B, e.g., where one or both of the televisions comprise a smart TV. In one example, router 165 may comprise a wired Ethernet router and/or an Institute for Electrical and Electronics Engineers (IEEE) 802.11 (Wi-Fi) router, and may communicate with respective devices in home network 160 via wired and/or wireless connections. Although STB/DVR 162A and STB/DVR 162B are illustrated and described as integrated devices with both STB and DVR functions, in other, further, and different examples, STB/DVR 162A and/or STB/DVR 162B may comprise separate STB and DVR devices.

Network 100 may also include a content distribution network (CDN) 170. In one example, CDN 170 may be operated by a different entity from the core network 110. In another example, CDN 170 may be operated by a same entity as the core network 110, e.g., a telecommunication service provider. In one example, the CDN 170 may comprise a collection of cache servers distributed across a large geographical area and organized in a tier structure. The first tier may comprise a group of servers that accesses content web servers (e.g., origin servers) to pull content into the CDN 170, referred to as an ingestion servers, e.g., ingest server 172. The content may include videos, content of various webpages, electronic documents, video games, etc. A last tier may comprise cache servers which deliver content to end users, referred to as edge caches, or edge servers, e.g., edge server 174. For ease of illustration, a single ingest server 172 and a single edge server 174 are shown in FIG. 1. In between the ingest server 172 and edge server 174, there may be several layers of servers (omitted from the illustrations), referred to as the middle tier. In one example, the edge server 174 may be multi-tenant, serving multiple content providers, such as core network 110, content providers associated with server(s) 149 in other network(s) 140, and so forth.

As mentioned above, TV servers 112 in core network 110 may also include one or more interactive TV/video-on-demand (VoD) servers and/or network-based DVR servers. Among other things, an interactive TV/VoD server and/or network-based DVR server may function as a server for STB/DVR 162A and/or STB/DVR 162B, one or more of mobile devices 157A, 157B, 167A and 167B, and/or PC 166 operating as a client video player. For example, STB/DVR 162A may present a user interface and receive one or more inputs (e.g., via remote control 168A) for a selection of a video. STB/DVR 162A may request the video from an interactive TV/VoD server and/or network-based DVR server, which may retrieve a manifest file for the video from one or more of application servers 114 and provide the manifest file to STB/DVR 162A. STB/DVR 162A may then obtain one or more portions of the video from one or more network-based servers, such as one of the TV servers 112, edge server 174 in CDN 170, and so forth, as directed via the manifest file. For instance, URL(s) and other information that may be used by a player device to request and obtain chunks of adaptive or non-adaptive bitrate video may be stored in the manifest file which may be obtained by the player device in advance of a streaming session.

To illustrate, the manifest file may direct the STB/DVR 162A to obtain the video from edge server 174 in CDN 170. The edge server 174 may already store the video (or at least a portion thereof) and may deliver the video upon a request from the STB/DVR 162A. However, if the edge server 174 does not already store the video, upon request from the STB/DVR 162A, the edge server 174 may in turn request the video from an origin server. The origin server which stores the video may comprise, for example, one of the servers 149 or one of the TV servers 112. The video may be obtained from an origin server via ingest server 172 before passing the video to the edge server 174. In one example, the ingest server 172 may also pass the video to other middle tier servers and/or other edge servers (not shown) of CDN 170. The edge server 174 may then deliver the video to the STB/DVR 162A and may store the video until the video is removed or overwritten from the edge server 174 according to any number of criteria, such as a least recently used (LRU) algorithm for determining which content to keep in the edge server 174 and which content to delete and/or overwrite.

It should be noted that a similar process may involve other devices, such as TV 163A or TV 163B (e.g., “smart” TVs), mobile devices 167A, 167B, 157A or 157B obtaining a manifest file for a video from one of the TV servers 112, from one of the servers 149, etc., and requesting and obtaining videos (e.g., the video chunks thereof) from edge server 174 of CDN 170 in accordance with corresponding URLs in the manifest file.

As mentioned above, one or more of the application servers 114 may represent a processing system for compressing and identifying sequences of uniform resource locators indicative of a target category. To illustrate, application server(s) 114 may collect URLs visited, browsed, accessed, or otherwise selected by various endpoint devices, such as mobile devices 157A, 157B, 167A, and 167B, and/or PC 166. For instance, selected URLs may be accessed via web browsers or other applications (“apps”) of such devices, including social networking applications, map applications, gaming applications, productivity applications, calendar and scheduling applications, and so forth. In one example, application server(s) 114 may collect URLs associated with usage of STBs/DVRs 162A and 162B, TV 163A, and/or TV 163B (e.g., URLs related to video and/or video chunk selections, URLs related to accessing of programming information via a television programming guide or the like, URLs accessed via browsers of TVs 163A and 163B (e.g., smart TVs), etc.). The URLs may be associated with communication sessions between such endpoint devices and various network-based devices, devices reachable via access network 120, wireless access network 150, core network 110, CDN 170, other networks 140, etc., such as servers 149, edge server 174, and TV servers 112.

In one example, the collections of URLs (e.g., URL histories) may be obtained from the endpoint devices directly. For instance, the endpoint devices may be configured, with permission/consent of the users and/or the device owners, to collect and report on a URL history for each respective device. Alternatively, or in addition, URL histories of various endpoint devices and/or the users thereof may be obtained from one or more network-based devices or processing systems, such as network elements 111A-111D, edge server 174, TV servers 112, and/or any other such device(s) that may be within a communication path. For instance, such network-based devices may generate a record of a communication by source or destination IP address, along with the URL and a timestamp.

In addition to collecting URL histories, application server(s) 114 may also store information regarding various users being associated with various target categories, such as users associated with fraudulent use of the communication network, users associated with a utilization of a network resource of the communication network, users associated with an accessing of a particular data content or a type of data content via the communication network, users associated with a change in endpoint devices or network access equipment, etc. In one example, application server(s) 114 may then identify, for a particular target category, those URLs that are most associated with the target category. For instance, application server(s) 114 may measure a probability of a URL being visited by known members of the target category, and then compare to a probability of visiting that URL by known non-members of the target category. Application server(s) 114 may then determine a ratio of visits by members of the target category to visits by non-members of the target category for each URL, and score/rank URLs based on this ratio. In one example, the ratios may be modified to account for standard deviation, errors, etc. After determining scores for all URLs, application server(s) 114 may then rank/order the URLs by score, and may select to keep a top “N” number of URLs by score/rank, URLs that exceed a threshold score, a top “N” percent of URLs, etc. In various examples, the number or percent of URLs to keep and/or the threshold score may be selected based upon different considerations, such as a desired number of URLs to keep, a maximum desired storage volume to store compressed URLs, a prediction accuracy of the machine learning model, and so forth.

In any case, after selecting the top URLs relating to a particular target category, application server(s) 114 may then compress URL histories to exclude URLs failing the threshold/cutoff (e.g., keeping those URLs deemed most important/relevant by score/rank). As referred to herein, these compressed URL histories may be referred to as a “URL sequence” or “compressed URL sequence.” Notably, a prediction model, e.g., a machine learning model, for detecting additional examples of the target category may then be trained by application server(s) 114 with these compressed URL sequences, e.g., using at least compressed URL sequences of known members of the target category as positive training examples. In one example, compressed URL sequences of known non-members of the target category may also be used as additional training data for the machine learning model (e.g., negative training examples). Notably, deep learning algorithms may experience a vanishing gradient problem. For instance, when feeding sequential data to such learning algorithms, there may be a diminishing value of older inputs such that anything older than X, e.g., older than 500 examples, becomes useless. Moreover, for a large percentage of users, URL histories may easily accumulate more than 500 URLs within 10 minutes to an hour. However, using the present approach, multiple days of data may be used because relevant URLs are retained and others are discarded.

In one example, the machine learning model may comprise a recurrent neural network (RNN). However, in other examples, the machine learning model may take a different form. In this regard, it should be noted that as referred to herein, a machine learning model (MLM) (or machine learning-based model) may comprise a machine learning algorithm (MLA) that has been “trained” or configured in accordance with input data (e.g., training data) to perform a particular service, e.g., to detect fraud and/or to provide a fraud indicator, or value indicative of a likelihood of fraud. Thus, in other examples, the present disclosure may incorporate various types of MLAs/models that utilize training data, such as a support vector machine (SVM), e.g., a linear or non-linear binary classifier, a multi-class classifier, a deep learning algorithm/model, such as another type of deep learning neural network or deep neural network (DNN), a generative adversarial network (GAN), a decision tree algorithms/models, such as gradient boosted decision tree (GBDT), a k-nearest neighbor (KNN) clustering algorithm/model, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth.

With the benefit of such a trained machine learning model, application server(s) 114 may continue to obtain URL histories, compress the URL histories to retain those URLs determined to be relevant/important per the example ranking methodology discussed above, feed these compressed URL sequences to the trained machine learning model as inputs, and obtain predictive scores from the machine learning model as outputs indicative of how likely/not likely the URL sequence is indicative of the target category (e.g., how similar/dissimilar is the URL sequence to the URL sequences of known members of the target category?). In other words, the output of the machine learning model is a score/prediction indicative of the likelihood that the user associated with the URL sequence is also a member of the target category or will be a member of the target category.

In addition to the foregoing, application server(s) 114 may also perform at least one action in the network 100 responsive to output(s) of the machine learning model, e.g., the measure(s) of which the compressed URL sequence(s) is/are indicative of the target category. For instance, application server(s) 114 may learn the numbers and/or percentages of user, their locations (and/or locations of the respective endpoint devices), and the utilization trends of such users, and may then perform the at least one action in response. For instance, application server(s) 114 may provide, to at least one recipient computing system, a measure of which URL sequence is indicative of the target category, an aggregate metric based upon the measure(s) of which number of URL sequences are indicative of the target category, and so forth. The application server(s) 114 may provide such information in the form of a notification or a report, a table, a spreadsheet, or a chart, a map, which may indicate a geographic distribution of users (or endpoint devices) who are (and/or are not) part of a target category, and so on. The at least one recipient computing system may comprise an endpoint device of a network operations personnel, or may comprise one or more additional automated computing systems.

In one example, application server(s) 114 may also represent a self-optimizing network (SON)/software defined network (SDN) controller that may function as a self-optimizing network (SON) orchestrator that is responsible for activating and deactivating, allocating and deallocating, and otherwise managing a variety of network components. For instance, application server(s) 114 may activate and deactivate antennas/remote radio heads of wireless access network 150, may steer antennas/remote radio heads of wireless access network 150 (e.g., adjusting vertical tilt angles, azimuth bearings, beamwidths, power levels, and or other settings), may allocate or deallocate (or activate or deactivate) baseband units in a BBU pool, may add (or remove) one or more network slices, and may perform other operations for adjusting configurations of components of wireless access network 150 in accordance with the present disclosure.

In one example, application server(s) 114 may represent an SDN controller that is responsible for instantiating, configuring, managing, and releasing VNFs to perform the functions of routers, switches, and other devices, provisioning routing tables and other operating parameters for the VNFs, and so forth. For example, in a SDN architecture, a SDN controller may instantiate VNFs on shared hardware, e.g., NFVI/host devices/SDN nodes, which may be physically located in various places. In one example, the configuring, releasing, and reconfiguring of SDN nodes is controlled by the SDN controller, which may store configuration codes, e.g., computer/processor-executable programs, instructions, or the like for various functions which can be loaded onto an SDN node. In another example, the SDN controller may instruct, or request an SDN node to retrieve appropriate configuration codes from a network-based repository, e.g., a storage device, to relieve the SDN controller from having to store and transfer configuration codes for various functions to the SDN nodes. Accordingly, application server(s) 114 representing an SDN controller may be connected directly or indirectly to any one or more network elements of core network 110, and of the network 100 in general.

Thus, in one example, at least one action in the network responsive to output(s) of the machine learning model may comprise application server(s) 114 allocating at least one additional resource of the communication network or removing at least one existing resource of the communication network, such as providing an additional content server or removing an existing content server, adding an additional network firewall or removing an additional network firewall, and so on. In one example, the at least one action in the network may alternatively or additionally comprise re-routing at least a portion of traffic in a selected portion of the network. For instance, if a new firewall is added or an existing firewall is removed, application server(s) 114 may update routing tables or other traffic flow mechanisms to send network traffic to such a new firewall, or to redirect network traffic from a firewall that is being deactivated/removed to a different firewall, and so on.

Similarly, in one example, the at least one action in the network may comprise load-balancing at least a portion of network traffic in the selected portion of the communication network. For instance, the output(s) of the machine learning model may be indicative of a demand prediction for a particular content or type of content at a particular time of day, day of the week, etc. from users in various locations. Thus, application server(s) 114 may be tasked with distributing user requests for such a content item to different content servers based upon the anticipated demand. For instance, some users (e.g., their respective endpoint devices) may be equally served by two content servers, whereas endpoint devices of other users may be in locations or have equipment that otherwise can only be served by one of the content servers. Accordingly, application server(s) may reserve capacity of one of the content servers for those users who cannot be directed elsewhere, while directing other users/endpoint devices to the alternate content server.

In one example, the at least one action in the network may include offloading at least a portion of traffic in a selected portion of the network, e.g., based upon anticipated/predicted demand, application server(s) 114 may offload a portion of traffic in the selected portion of the network before it is overloaded. In still another example, the at least one action in the network may include applying a denial-of-service mitigation measure in the selected portion of the network, e.g., blocking, slowing, or redirecting selected flows or connections, etc. For instance, the target category may be a fraudulent use of the network, and the outputs of the machine learning model may indicate a large number of users/endpoint devices are or will be engaged in a botnet, or the like. For example, these endpoint devices may have URL sequences indicative of connecting to command and control servers to obtain instructions for a denial of service attack, indicative of attempted connections to a domain being attacked, etc.

Further details regarding the functions that may be implemented by application servers 114, mobile devices 157A, 157B, 167A, and 167B, PC 166, TV servers 112, servers 149, edge server 174, ingest server 172, STBs/DVRs 162A and 162B, TV 163A, and/or TV 163B, are discussed in greater detail below in connection with the example of FIG. 2. In addition, it should be noted that the network 100 may be implemented in a different form than that which is illustrated in FIG. 1, or may be expanded by including additional endpoint devices, access networks, network elements, application servers, etc. without altering the scope of the present disclosure. For example, core network 110 is not limited to an IMS network. Wireless access network 150 is not limited to a UMTS/UTRAN configuration. Similarly, the present disclosure is not limited to an IP/MPLS network for VoIP telephony services, or any particular type of broadcast television network for providing television services, and so forth.

FIG. 2 illustrates a flowchart of a method 200 for compressing and identifying sequences of uniform resource locators indicative of a target category, in accordance with the present disclosure. In one example, the method 200 is performed by one or more of application server(s) 114 of FIG. 1, or any one or more components thereof, such as a processing system, or by one of these devices in conjunction with other devices and/or components of network 100 of FIG. 1. In one example, the steps, functions, or operations of method 200 may be performed by a computing device or system 300, and/or a processing system 302 as described in connection with FIG. 3 below. For instance, the computing device or system 300 may represent any one or more components of the network 100 that is/are configured to perform the steps, functions and/or operations of the method 200. Similarly, in one example, the steps, functions, or operations of method 200 may be performed by a processing system comprising one or more computing devices collectively configured to perform various steps, functions, and/or operations of the method 200. For instance, multiple instances of the computing device or processing system 300 may collectively function as a processing system, and each instance may represent one of application servers 114, edge server 174, ingest server 172, TV servers 112, and so forth in FIG. 1. For illustrative purposes, the method 200 is described in greater detail below in connection with an example performed by a processing system, such as processing system 302. The method 200 begins in step 205 and proceeds to step 210.

At step 210, the processing system identifies a plurality of URLs associated with a target category of a plurality of users of a communication network. For instance, step 210 may include, for each respective URL of the plurality of URLs associated with the target category, determining a percentage of the plurality of users known to be of the target category having the respective URL in URL histories of the percentage of the plurality of users. The processing system may then generate a score for the respective URL based upon the percentage of the plurality of users known to be of the target category having the respective URL in the URL histories of the percentage of the plurality of users. In addition, in one example, a respective URL is selected to be included in the plurality of URLs associated with the target category when the score for such URL exceeds a threshold.

In one example, step 210 may further include, for each respective URL of the plurality of URLs associated with the target category, determining a second percentage of a plurality of users known to not be of the target category having the respective URL in URL histories of the second percentage of the plurality of users known to not be of the target category. In such an example, the score may be generated further based upon the second percentage of the plurality of users known to not be of the target category having the respective URL in the URL histories of the second percentage of the plurality of users. In other words, the score for a particular URL may also be based upon percentage of users who are not in the category who also visit the URL. For instance, the score may be a ratio of the percentage of users who are in the category who visit the URL to the percentage of users who are not in the category who also visit the URL, a percentage of users who are in the category who visit the URL to a total number of users who visit the URL, etc. In another example, the score may be a ranking of the respective uniform resource locator by any of the above metrics in relation to other URLs. In such case, a threshold for selecting a URL to be included in the plurality of uniform resource locators associated with the target category may be a top N number of URLs, a top N percent of URLs in relation to all URLs considered, or the like. In one example, the threshold is set based upon a defined maximum number of the plurality of URLs associated with the target category, e.g., the top 200-1000 URLs ranked by score indicating the URLs most associated with the target category. In one example, the threshold is set based upon a defined average number of URLs to be retained within the plurality of sequences.

In one example, step 210 may further include removing defined sensitive URLs from the plurality of URLs associated with the target category. In various examples, the target category may comprise users associated with a utilization of a network resource of the communication network, users associated with an accessing of a particular data content or a type of data content via the communication network, users associated with fraudulent use of the communication network, users associated with a change in network access equipment (e.g., users changing mobile endpoint devices, set-top boxes, gateways, routers, and so on).

In another example, step 210 may include, for each respective string of a plurality of strings, determining a percentage of the plurality of users known to be of the target category having the respective string in URL histories of the percentage of the plurality of users. For example, strings within a URL “www.example.com/february/2021” may comprise: “www,” “example,” “com,” “February,” and “2021.” The processing system may then generate a score for the respective string based upon the percentage of the plurality of users known to be of the target category having the respective string in the URL histories of the percentage of the plurality of users. Some strings may be relatively non-informative, such as “www”, while others may be more informative, such as “February” and “2021.” In such an example, step 210 may further include, for each respective URL of the plurality of URLs associated with the target category: identifying strings within the respective URL and generating a score for the respective URL comprising a combination of scores of the strings within the respective URL. For instance, in such case, the respective URL may be selected to be included in the plurality of URLs associated with the target category when the score of the respective URL exceeds a threshold, such as discussed above. In one example, step 210 may further include, for each respective string, determining a second percentage of a plurality of users known to not be of the target category having the respective string in URL histories of the second percentage of the plurality of users known to not be of the target category. In such an example, the score for the respective string may be generated further based upon the second percentage of the plurality of users known to not be of the target category having the respective string in the URL histories of the second percentage of the plurality of users.

At step 220, the processing system identifies a plurality of sequences of URLs, wherein each sequence of the plurality of sequences comprises URLs from among the plurality of URLs, wherein each sequence of the plurality of sequences is associated with a respective user from among the plurality of users known to be of the target category (e.g., a different user of the plurality of users known to be of the target category). In one example, step 220 may comprise, for each respective sequence of the plurality of sequences and for each respective user from among the plurality of users known to be of the target category, extracting URLs from among the plurality of URLs from a URL history associated with the respective user, wherein the respective sequence comprises the URLs that are extracted (and wherein URLs from the URL history that are not extracted are discarded).

At optional step 225, the processing system may identify a second plurality of sequences of URLs, wherein each sequence of the second plurality of sequences comprises URLs from among the plurality of URLs, wherein each sequence of the second plurality of sequences is associated with a respective user from among a plurality of users known to not be of the target category. For instance, step 225 may be similar to step 220, but with respect to users known to not be of the target category (and their respective URL histories).

At step 230, the processing system trains a machine learning model with the plurality of sequences to detect additional sequences that are indicative of the target category. For instance, the machine learning model may be trained, based upon the plurality of sequences, to detect additional sequences that are indicative of the target category (e.g., additional sequences that are similar to the plurality of sequences that were used for the training). In an example where the method 200 includes optional step 225, the machine learning model may be further trained with the second plurality of sequences as negative training examples. In one example, the machine learning model comprises a recurrent neural network. In one example, compressed URL sequences may then be fed to the trained machine learning model as inputs, and the machine learning model may generate outputs, e.g., values or scores, indicative of how likely/not likely each URL sequence is indicative of the target category (e.g., how similar/dissimilar is the URL sequence to the URL sequences of known members of the target category?). In other words, the output of the machine learning model is a score/prediction indicative of the likelihood that the user associated with the URL sequence is also a member of the target category or will be a member of the target category.

At step 240, the processing system obtains a set of uniform resource locators associated with an additional user, e.g., a uniform resource locator history of a user with an unknown status with regard to belonging/not belonging to the target category.

At step 250, the processing system identifies a sequence comprising URLs, from among the plurality of URLs, that are contained within the set of URLs. For instance, step 250 may comprise similar operations as step 220 and/or optional step 225, such as extracting URLs, from among the plurality of URLs associated with the target category, from the set of URLs (e.g., the URL history associated with the additional user), where URLs from the URL history that are not extracted are discarded. In other words, step 250 may comprise compressing the URL history to include those URLs that are relevant/important to the target category (e.g., as determined at step 210 above).

At step 260, the processing system applies the sequence as an input the machine learning model that has been trained.

At step 270, the processing system obtains an output of the machine learning model quantifying a measure of which the sequence is indicative of the target category, e.g., a value/score/prediction indicating a degree to which the user belongs/does not belong to the target category.

At step 280, the processing system performs at least one action in the communication network responsive to the measure of which the sequence is indicative of the target category. For instance, the at least one action may comprise at least one of: re-routing at least a portion of network traffic in a selected portion of the communication network, load-balancing at least a portion of network traffic in the selected portion of the communication network, offloading at least a portion of network traffic in the selected portion of the communication network, applying a denial-of-service mitigation measure in the selected portion of the communication network, or the like. In one example, step 280 may alternatively or additionally comprise at least one of: allocating at least one additional resource of the communication network responsive to the measure of which the sequence is indicative of the target category or removing at least one existing resource of the communication network responsive to the measure of which the sequence is indicative of the target category.

In accordance with step 280, an additional resource that may be added or an existing resource that may be removed (e.g., deactivated and/or deallocated) may be a hardware component of the network, or may be provided by hardware, e.g., bandwidth on a link, line card, router, switch, or other processing node, a CDN storage resource, a VM and/or a VNF, etc. Similarly, the additional resource may be a caching of a primary content, or a secondary content that is similar or related to the primary content associated with the target category that is predicted to be in demand at one or more future time periods and in one or more geographic locations and/or network regions.

In still another example, step 280 may alternatively or additionally include providing, to at least one recipient computing system, at least one of: the measure of which the sequence is indicative of the target category, or an aggregate metric based upon (1) the measure of which the sequence is indicative of the target category and (2) a plurality of additional measures of which other sequences are determined, via the machine learning model, to be indicative of the target category. As noted above, the metric and/or the aggregate metric may be presented in the form of a notification or a report, a table, a spreadsheet, or a chart, a map, which may indicate a geographic distribution of users (or endpoint devices) who are (and/or are not) part of a target category, and so on.

Following step 280, in one example, the method 200 may return to step 210, wherein step 210 and subsequent steps of the method 200 may be repeated to identify new training examples, to retrain the machine learning model, and so forth. In one example, following step 280, the method 200 may return to step 240 for one or more additional iterations/cycles, wherein step 240 and subsequent steps of the method 200 may be repeated to obtain URL histories of additional users, to compress such histories into compressed URL sequences, to apply the compressed URL sequences to the machine learning model, to obtain output measures, and to perform one or more actions in the communication network responsive to the measure(s) of which the sequence(s) is/are indicative of the target category. Otherwise, following step 280, the method 200 may proceed to step 295 where the method 200 ends.

It should be noted that the method 200 may be expanded to include additional steps, or may be modified to replace steps with different steps, to combine steps, to omit steps, to perform steps in a different order, and so forth. For instance, in one example the processing system may repeat one or more steps of the method 200, such as steps 210-280, or steps 240-280, as noted above. In one example, step 220 may include removing sensitive URLs, e.g., if not excluded from the plurality of URLs associated with the target category that are identified at step 210. In one example, the method 200 may further include selecting or setting the threshold applied at step 210 for inclusion of URLs in the plurality of URLs associated with the target category, e.g., based upon a desired maximum storage volume for storing compressed URL sequences, based upon a desired minimum accuracy of the machine learning model's predictions, etc. In this regard, in one example, the method 200 may also include monitoring accuracy of predictions and updating/retraining the machine learning model with additional examples after the status of an unknown user with respect to the target category becomes known. Similarly, additional examples of users known to be of the target category may be used to re-evaluate the plurality of URLs associated with the target category. For instance, the URLs most associated with the target category, e.g., as determined per the operations of step 210, may change over time as users' behaviors and preferences change. Thus, these and other modifications are all contemplated within the scope of the present disclosure.

In addition, although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. In addition, one or more steps, blocks, functions, or operations of the above described method 200 may comprise optional steps, or can be combined, separated, and/or performed in a different order from that described above, without departing from the example embodiments of the present disclosure. The method 200 may also be expanded to include additional steps. Thus, these and other modifications are all contemplated within the scope of the present disclosure.

FIG. 3 depicts a high-level block diagram of a computing device or processing system specifically programmed to perform the functions described herein. For example, any one or more components or devices illustrated in FIG. 1 or described in connection with the method 200 may be implemented as the system 300. As depicted in FIG. 3, the processing system 300 comprises one or more hardware processor elements 302 (e.g., a central processing unit (CPU), a microprocessor, or a multi-core processor), a memory 304 (e.g., random access memory (RAM) and/or read only memory (ROM)), a module 305 for compressing and identifying sequences of uniform resource locators indicative of a target category, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 306 may also include antenna elements, transceivers, power units, and so forth. Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200, or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 305 for compressing and identifying sequences of uniform resource locators indicative of a target category (e.g., a software program comprising computer-executable instructions) can be loaded into memory 304 and executed by hardware processor element 302 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for compressing and identifying sequences of uniform resource locators indicative of a target category (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
identifying, by a processing system including at least one processor, a plurality of uniform resource locators associated with a target category of a plurality of users of a communication network;
identifying, by the processing system, a plurality of sequences of uniform resource locators, wherein each sequence of the plurality of sequences comprises uniform resource locators from among the plurality of uniform resource locators, wherein each sequence of the plurality of sequences is associated with a user from among the plurality of users known to be of the target category;
training, by the processing system, a machine learning model with the plurality of sequences to detect additional sequences that are indicative of the target category;
obtaining, by the processing system, a set of uniform resource locators associated with an additional user;
identifying, by the processing system, a sequence comprising uniform resource locators, from among the plurality of uniform resource locators, that are contained within the set of uniform resource locators;
applying, by the processing system, the sequence as an input to the machine learning model that has been trained;
obtaining, by the processing system, an output of the machine learning model quantifying a measure of which the sequence is indicative of the target category; and
performing, by the processing system, at least one action in the communication network responsive to the measure of which the sequence is indicative of the target category.

2. The method of claim 1, wherein the at least one action comprises at least one of:
re-routing at least a portion of traffic in a selected portion of the communication network;
load-balancing at least a portion of traffic in the selected portion of the communication network;
offloading at least a portion of traffic in the selected portion of the communication network; or
applying a denial-of-service mitigation measure in the selected portion of the communication network.

3. The method of claim 1, wherein the at least one action comprises:
providing, to at least one recipient computing system, at least one of:
the measure of which the sequence is indicative of the target category; or
an aggregate metric based upon the measure of which the sequence is indicative of the target category and a plurality of additional measures of which other sequences are determined, via the machine learning model, to be indicative of the target category.

4. The method of claim 1, wherein the at least one action comprises at least one of:
allocating at least one additional resource of the communication network responsive to the measure of which the sequence is indicative of the target category; or
removing at least one existing resource of the communication network responsive to the measure of which the sequence is indicative of the target category.

5. The method of claim 1, wherein the identifying the plurality of uniform resource locators associated with the target category comprises, for each respective uniform resource locator of the plurality of uniform resource locators associated with the target category:
determining a percentage of the plurality of users known to be of the target category having the respective uniform resource locator in uniform resource locator histories of the percentage of the plurality of users; and
generating a score for the respective uniform resource locator based upon the percentage of the plurality of users known to be of the target category having the respective uniform resource locator in the uniform resource locator histories of the percentage of the plurality of users, wherein the respective uniform resource locator is selected to be included in the plurality of uniform resource locators associated with the target category when the score exceeds a threshold.

6. The method of claim 5, wherein the identifying the plurality of uniform resource locators associated with the target category further comprises, for each respective uniform resource locator of the plurality of uniform resource locators associated with the target category:
determining a second percentage of a plurality of users known to not be of the target category having the respective uniform resource locator in uniform resource locator histories of the second percentage of the plurality of users known to not be of the target category, wherein the score is generated further based upon the second percentage of the plurality of users known to not be of the target category having the respective uniform resource locator in the uniform resource locator histories of the second percentage of the plurality of users.

7. The method of claim 5, wherein the threshold is set based upon a defined maximum number of the plurality of uniform resource locators associated with the target category.

8. The method of claim 5, wherein the threshold is set based upon a defined average number of uniform resource locators to be retained within the plurality of sequences.

9. The method of claim 5, wherein the identifying the plurality of uniform resource locators associated with the target category further comprises:
removing defined sensitive uniform resource locators from the plurality of uniform resource locators associated with the target category.

10. The method of claim 1, wherein the identifying the plurality of sequences of uniform resource locators comprises, for each respective sequence of the plurality of sequences and for each respective user from among the plurality of users known to be of the target category:
extracting uniform resource locators from among the plurality of uniform resource locators from a uniform resource locator history associated with the each respective user, wherein the respective sequence comprises the uniform resource locators that are extracted.

11. The method of claim 10, wherein uniform resource locators from the uniform resource locator history that are not extracted are discarded.

12. The method of claim 1, wherein the machine learning model comprises a recurrent neural network.

13. The method of claim 1, wherein the target category comprises:
users associated with a utilization of a network resource of the communication network; or
users associated with an accessing of a particular data content or a type of data content via the communication network.

14. The method of claim 1, wherein the target category comprises:
users associated with a fraudulent use of the communication network.

15. The method of claim 1, wherein the target category comprises:
users associated with a change in network access equipment.

16. The method of claim 1, wherein the identifying the plurality of uniform resource locators associated with the target category comprises, for each respective token of a plurality of tokens: determining a percentage of the plurality of users known to be of the target category having the respective token in uniform resource locator histories of the percentage of the plurality of users; and
generating a score for the respective token based upon the percentage of the plurality of users known to be of the target category having the respective token in the uniform resource locator histories of the percentage of the plurality of users.

17. The method of claim 16, wherein the identifying the plurality of uniform resource locators associated with the target category further comprises, for each respective uniform resource locator of the plurality of uniform resource locators associated with the target category:
identifying tokens within the respective uniform resource locator; and
generating a score for the respective uniform resource locator comprising a combination of scores of the tokens within the respective uniform resource locator, wherein the respective uniform resource locator is selected to be included in the plurality of uniform resource locators associated with the target category when the score of the respective uniform resource locator exceeds a threshold.

18. The method of claim 16, wherein the identifying the plurality of uniform resource locators associated with the target category further comprises, for each respective token:
determining a second percentage of a plurality of users known to not be of the target category having the respective token in uniform resource locator histories of the second percentage of the plurality of users known to not be of the target category, wherein the score for the respective token is generated further based upon the second percentage of the plurality of users known to not be of the target category having the respective token in the uniform resource locator histories of the second percentage of the plurality of users.

19. An apparatus comprising:
a processing system including at least one processor; and
a computer-readable medium storing instructions which, when executed by the processing system, cause the processing system to perform operations, the operations comprising:
identifying a plurality of uniform resource locators associated with a target category of a plurality of users of a communication network;
identifying a plurality of sequences of uniform resource locators, wherein each sequence of the plurality of sequences comprises uniform resource locators from among the plurality of uniform resource locators, wherein each sequence of the plurality of sequences is associated with a user from among the plurality of users known to be of the target category;
training a machine learning model with the plurality of sequences to detect additional sequences that are indicative of the target category;
obtaining a set of uniform resource locators associated with an additional user;
identifying a sequence comprising uniform resource locators, from among the plurality of uniform resource locators, that are contained within the set of uniform resource locators;
applying the sequence as an input to the machine learning model that has been trained;
obtaining an output of the machine learning model quantifying a measure of which the sequence is indicative of the target category; and
performing at least one action in the communication network responsive to the measure of which the sequence is indicative of the target category.

20. A non-transitory computer-readable medium storing instructions which, when executed by a processing system including at least one processor, cause the processing system to perform operations, the operations comprising:
identifying a plurality of uniform resource locators associated with a target category of a plurality of users of a communication network;
identifying a plurality of sequences of uniform resource locators, wherein each sequence of the plurality of sequences comprises uniform resource locators from among the plurality of uniform resource locators, wherein each sequence of the plurality of sequences is associated with a user from among the plurality of users known to be of the target category;
training a machine learning model with the plurality of sequences to detect additional sequences that are indicative of the target category;
obtaining a set of uniform resource locators associated with an additional user;
identifying a sequence comprising uniform resource locators, from among the plurality of uniform resource locators, that are contained within the set of uniform resource locators;
applying the sequence as an input to the machine learning model that has been trained;
obtaining an output of the machine learning model quantifying a measure of which the sequence is indicative of the target category; and
performing at least one action in the communication network responsive to the measure of which the sequence is indicative of the target category.
